(19) United States
(12) Patent Application Publication
(10) Pub. No.: US 2022/0074220 A1
(43) Pub. Date: Mar. 10, 2022

(54) MODULAR SYSTEM FOR TRANSFORMING A VEHICLE PARKING SPACE INTO A MULTIFUNCTIONAL

(71) Applicant: Olena OPESKINA, Odesa (UA)

(72) Inventor: Olena OPESKINA, Odesa (UA)

(21) Appl. No.: 17/309,886

(22) PCT Filed: Dec. 10, 2019
(86) PCT No.: PCT/IB2019/060632

§ 371 Date: Jun. 28, 2021

(30) Foreign Application Priority Data
Dec. 27, 2018 (UA) U201812993

(51) Int. Cl. E04H 6/10; B60L 53/51

(52) U.S. Cl. CPC E04H 6/10; B60L 53/51

(57) ABSTRACT

A modular system for transforming a vehicle car park into a multifunctional environment, which consists of a frame and additional modules, is different and characterized by a system for transforming parking equipment, namely a frame in the form of columns of various geometric shapes and elements of a given shape, which are attached to the columns of the frame in a detachable manner that divides the site into parking zones of a given size, with roof, frame modules of various geometric shapes and sizes, inter-connected in a detachable or permanent way, regardless of the type of geometric shape and size of the frame module.

### FIELD OF TECHNOLOGY

The invention relates to the field of construction and transport and is intended to improve the method and system of parking of vehicles, in particular electric vehicles, and rationalise the use of parking spaces with the possibility of their quick conversion for other activities.

### BACKGROUND

With the development of road transport in the first half of the 20th century, the first traffic jams began to form on the streets of cities. Along with this problem, another one appeared—the problem of parking a car.

For public places where there is dense development and there is not enough parking space, mechanical parking lots of different types and forms were invented and implemented. In places where the building area allowed it to be used for horizontal placement of vehicles (shopping centres, buildings adjoining open sites, sites with low building density, etc) open parking zones were organized.

Most of the time, a site of this sort reserved for parking remains underutilised and the possibility of its adaptation to other activities is limited. Today in the world market there is a demand for the creation of modular horizontal parking systems that can easily change their functional purpose.

Modular building systems were used as far back as 1931, as shown in a U.S. Pat. No. 1,793,188.

U.S. Pat. No. 3,055,461 describes structural profiles interconnected to form structural elements.

U.S. Pat. No. 3,751,865 describes a modular building structure made of individual panels. Individual panels consist of extruded metal (such as aluminum) frames which support the panels with a clamp in the molding.

U.S. Pat. No. 4,019,291 describes internal wall systems. Each section of the carcass section consists of at least one pair of vertically extended studs and, as a rule, with horizontal upper and lower studs for securing the studs in a horizontal position. Each section of the frame section consists of elongated slots for electrical wires, telephone wires and other equipment.

U.S. Pat. No. 4,443,986 describes panels designed to divide large rooms into a number of workstations.

U.S. Pat. No. 5,117,602 describes a building that includes many structural elements interconnected to form interconnected walls and floors.

Despite the fact that many of the systems described above are still used today, there is still a need for a prefabricated structure that can be built quickly with panels that can effectively change the functional purpose of all or part of the site.

### THE ESSENCE OF THE INVENTION

The basis of the invention is to create a vehicle parking system, while ensuring maximum efficiency in the use of the parking area, multifunctional use of frame elements of the car park and a quick change in the functional purpose of the site (creation of permanent or temporary enclosed premises, increasing the number of services in the parking area, generating electric and heat and providing electric vehicle charging).

The problem is solved by a modular system for transforming a car park into a multifunctional environment, which consists of transformed car parking spaces: a frame in the form of columns of various geometric shapes that divide the site into parking zones of a given size, with roof, frame modules of various geometric shapes and sizes, interconnected in a detachable or permanent way, regardless of the type of geometric shape and size of the module frame.

At the same time, it is envisaged that recharging electric batteries from a photovoltaic system and/or mains power supply will be present at the site.

The columns of the frame carcass divide the site into parking zones so that from each parking zone has access to electrical equipment.

In addition a photovoltaic system or other systems can be placed on the roof.

The columns of the frame can be attached either permanently or on a detachable way to the car parking area

The column consists of the column itself and of the elements of a given shape mechanically attached to the column in a detachable way.

Elements of the columns may have a tree shape.

### FIGURES

The invention is presented in the following figures (schemes):

FIG. 1—view of the frame module.

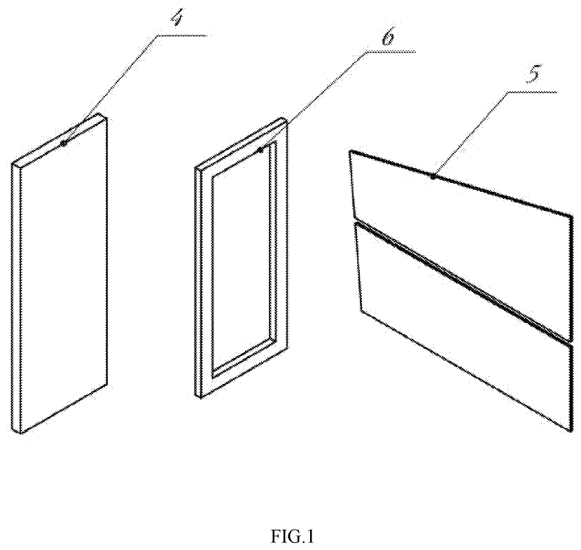

FIG. 2—view of the column frame.

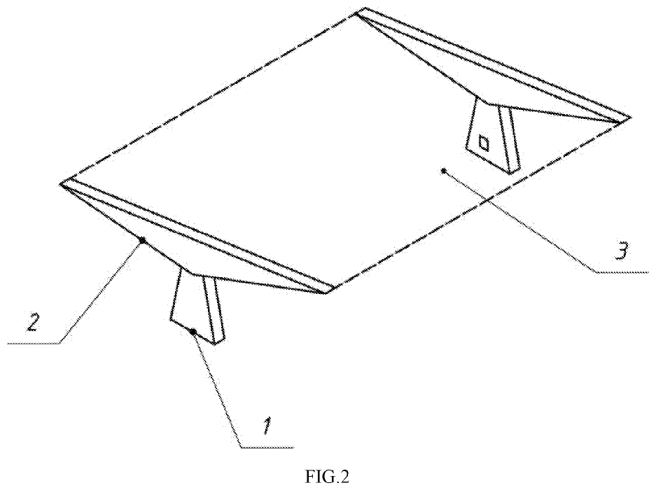

FIG. 3—view of the column frame.

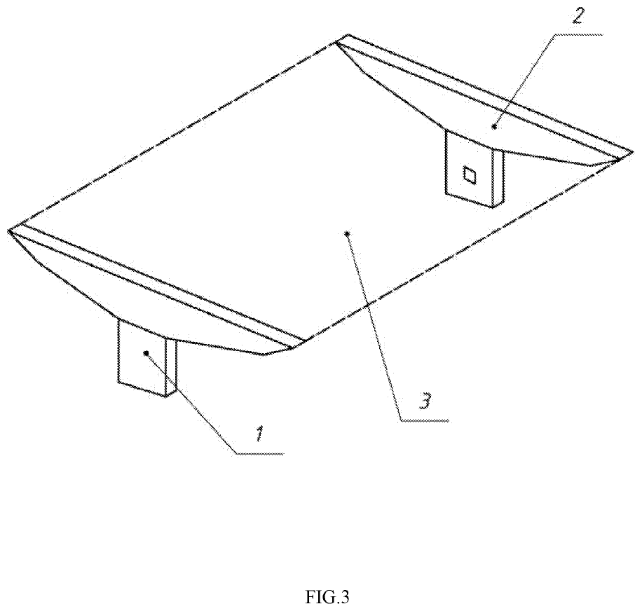

FIG. 4 is a schematic representation of the process of transforming a parking zone into an enclosed space using frame modules.

FIG. 5 is a view of a room transformed using frame modules.

FIG. 6 is a view of a room transformed using frame modules.

### DETAILED DESCRIPTION OF THE INVENTION

The invention is as follows. Between the parking areas on a hard surface frame in the form of columns 1 is installed using a detachable and/or permanent method, depending on the needs of the owner of the structure. Elements of various geometric shapes 2 (tree-shaped elements are shown in the drawings), which form the supports of the roof of the modular system 3, are installed in a detachable way over the columns The created frame forms a sectional distribution of the open parking space, creating separate parking spaces of a size determined by the customer in accordance with his/her needs. This structure allows you to quickly create parking spaces in an open area with at least access to the power supply network, thereby turning a conventional open-type parking lot into a parking lot where electric vehicles can recharge their batteries.

The columns of the frame form the supports of the roof of the modular system 3. The roof of the modular system can be made in the form of a canopy over the parking areas and can protect vehicles in bad weather. The photovoltaic system or other user support systems can be placed on the roof. The photovoltaic system allows you to create a system for recharging electric vehicles, where the main power network is not available, or to act as an additional or backup power supply system along with the main power network.

If the owner needs to turn the open parking area into enclosed sections, the vertical frames-modules are installed between the frames of the modular system of sections. The modules-frames have different geometric shapes depending on the type and geometry of the frame created. The frame modules can have standard dimensions, which can provide a combination of different frames between each other and the frame in a detachable way without the use of additional equipment. The module frames can be either solid 4-5, or in the form of a frame with windows/transparent elements of 6.

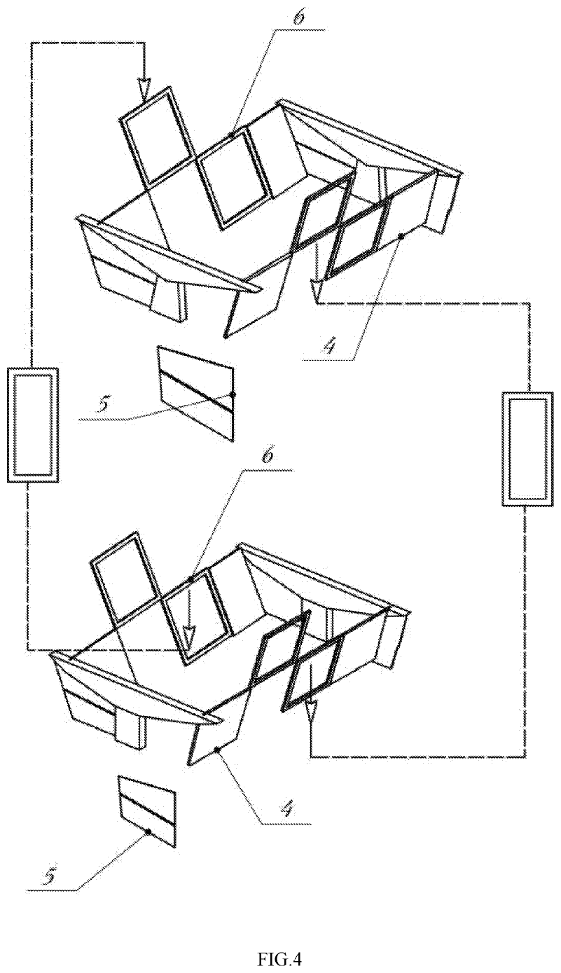

FIG. 4 schematically shows the process of transforming a parking zone into an enclosed space using frame modules.

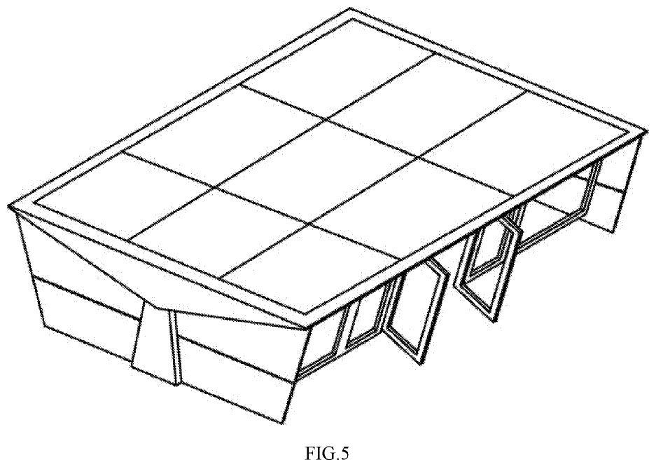

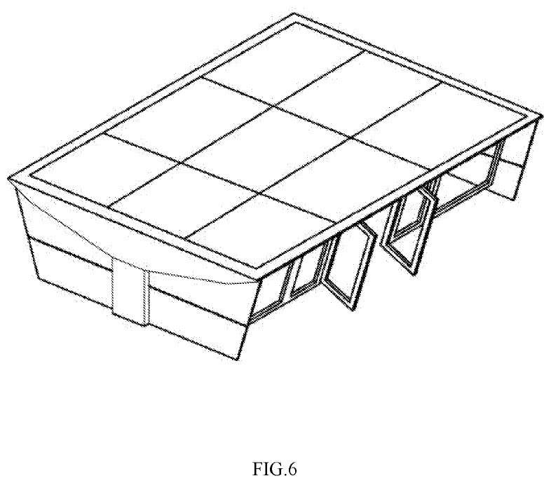

FIG. 5-6 schematically shows a view of a room transformed using frame modules.

It should be noted that the words «contains, includes, folds» does not exclude the presence of other elements or steps other than those listed, and also does not exclude the presence of many sets of such elements.

The above solution is for example only and does not limit the legal protection. Professionals may be apparent to other solutions, the use of options, objectives and functions included in the scope of the claimed invention.

1. (canceled)

2. (canceled)

3. (canceled)

4. (canceled)

5. (canceled)

6. A method of transforming a vehicle park to create enclosed premises, the method comprising:
forming a frame to divide the car park into sections, the frame comprising a plurality of columns, a plurality of support elements and a roof; and installing a plurality of frame modules between adjacent columns of the plurality of columns to create the enclosed premises; wherein:
the plurality of support elements of the frame are detachably installed over the plurality of columns of the frame; the plurality of frame modules are detachably installed between adjacent columns of the plurality of columns; at least one frame module of the plurality of frame modules is solid; and
at least one frame module of the plurality of frame modules is in the form of a frame with a transparent element.

7. The method of transforming a vehicle park according to claim 6, the method further comprising:
placing a photovoltaic system on the roof.

8. A vehicle park transformation system to create enclosed premises on a vehicle park, the system comprising: a frame including a plurality of columns, a plurality of support elements and a roof; wherein each support element of the plurality of support elements is detachably mounted on a column of the plurality of columns, the plurality of columns and the plurality of support elements support the roof, and the frame creates separate parking spaces; and wherein the system further comprises:
a plurality of frame modules; wherein each frame module of the plurality of frame modules is configured to interconnect with an adjacent frame module of the plurality of frame modules and to the frame in a detachable way to create the enclosed premises, at least one frame module of the plurality of frame modules is solid, and at least one frame module of the plurality of frame modules is in the form of a frame with a transparent element.

9. The vehicle park transformation system according to claim 8, further comprising:
a photovoltaic system on the roof configured to provide electric vehicle charging.
